(19) United States
(12) Patent Application Publication
(10) Pub. No.: US 2014/0032361 A1
(43) Pub. Date: Jan. 30, 2014

(54) METHODS AND APPARATUS FOR IDENTIFYING PRODUCTS AND SERVICES IN MEDIA CONTENT

(71) Applicants: Gregory David Gudorf, Los Angeles, CA (US); Basil Badawiyeh, Santa Clarita, CA (US); Joel M. Fogelson, Pasadena, CA (US)

(72) Inventors: Gregory David Gudorf, Los Angeles, CA (US); Basil Badawiyeh, Santa Clarita, CA (US); Joel M. Fogelson, Pasadena, CA (US)

(21) Appl. No.: 14/111,348

(22) PCT Filed: Jun. 26, 2012
(86) PCT No.: PCT/US12/44203

§ 371 Date: Oct. 11, 2013

Related U.S. Application Data
(60) Provisional application No. 61/502,319, filed on Jun. 28, 2011.

(51) Int. Cl. G06Q 30/06

(52) U.S. Cl. CPC G06Q 30/0625
USPC 705/26.7

(57) ABSTRACT

A unique identifier is used to identify products and services in media content in a method which includes receiving a request for information regarding a product or service identifiable in content being presented on a display, in response to the received request, determining a unique identifier for the product or service, determining if information for an alternate product or service should be returned in response to the request and if alternate product or service information should be returned in response to the request, determining a unique identifier for the alternate product or service. The process further includes searching for the unique identifier of the product or service in the original request or the alternate product or service in a database of unique identifiers to obtain product or service information for the product or service for which information is to be returned. The information retrieved can include sales information.

### CROSS-REFERENCE TO RELATED APPLICATIONS

This application claims priority from U.S. Provisional Application Ser. No. 61/502,319 filed Jun. 28, 2011, which is incorporated by reference herein in its entirety.

### FIELD OF THE INVENTION

The present invention generally relates to media content and, more particularly, to a methods and apparatus for identifying products and services in media content.

### BACKGROUND OF THE INVENTION

In the arena of delivering media and experiences, around the delivery of such media, many media owners/providers want to upsell (push) services and products to a user watching the media program and as such, such products or services must be readily identifiable in the media content.

### SUMMARY OF THE INVENTION

Embodiments of the present invention address the deficiencies of the prior art by providing methods and apparatus for identifying products and services and in various embodiments, providing product purchase information for such products or services presented on a display.

In one embodiment of the present invention, a method for identifying products and services for obtaining information includes receiving a request for information regarding a product or service identifiable in content being presented on a display, in response to the received request, determining a unique identifier for the product or service, and determining if information for an alternate product or service should be returned in response to the request. If alternate product or service information should be returned in response to the request, a unique identifier is determined for the alternate product or service. The method further includes searching for the unique identifier of the product or service in the original request or the alternate product or service in a database of unique identifiers to determine if product or service information exists for the product or service for which information is to be returned and returning such information to a location identified by the request for information.

In an alternate embodiment of the present invention, an apparatus for identifying products or services includes a memory for storing control programs and product and service information and a processor for executing the stored control programs. In such an embodiment, the apparatus is configured to receive a request for information regarding a product or service identifiable in content being presented on a display, in response to the received request, determine a unique identifier for the product or service, and determine if information for an alternate product or service should be returned in response to the request. If alternate product or service information should be returned in response to the request, determine a unique identifier for the alternate product or service. The apparatus is further configured to search for the unique identifier of the product or service in the original request or the alternate product or service in a database of unique identifiers to determine if product or service information exists for the product or service for which information is to be returned and communicate related information found in the database to a device identified by the request for information.

In an alternate embodiment of the present invention, a method for identifying products and services includes establishing a relationship between objects in media content and unique code identifiers, populating the established relationship with relevant data and storing the populated, established relationship.

In an alternate embodiment of the present invention, a method for upselling a product or service identified in media content presented on a display includes requesting information associated with a received unique identifier and upon receiving information associated with the unique identifier, determining if the unique identifier identifies a product or service. If the unique identifier identifies a product the method includes requesting additional information regarding the product if necessary, rendering the unique identifier to identify a specific product, communicating with a retailer for initiating a purchase order for the identified product and using user profile information to complete the purchase order. If the unique identifier identifies a service, the method includes requesting additional information regarding the service if necessary and determining a number of devices that are to be used to render the service. If a single device is be used to render the service, the method includes identifying the single device using a modality field in the unique identifier and the rendering the service on the single device. If multiple devices are to be used to render the service, the method includes determining the multiple devices using at least one modality field in the unique identifier, determining a location of the multiple devices if not referenced in the modality field and rendering the service on the multiple devices.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for identifying products and services in accordance with an embodiment of the present invention; and

FIG. 2 depicts a high-level block diagram of a UPID server applicable for use in the system of FIG. 1 in accordance with an embodiment of the present invention;

FIG. 3 depicts a table which presents a generic nomenclature used to describe a product and or service in which one or a multiplicity of fields can be used for referencing a product in accordance with one embodiment of the present invention;

FIG. 4 depicts a table which presents different commands that can be submitted to a server, such as UPID server, from which Extensible Markup Language (XML) data can be returned in accordance with one embodiment of the present invention;

FIG. 5 depicts a flow diagram of a method for identifying products and/or services in accordance with an embodiment of the present invention;

FIG. 6 depicts a table which presents examples of information that can be placed within the auxiliary information in accordance with an embodiment of the present invention;

FIG. 7 depicts a flow diagram of a method for associating media assets, attributes codes, and UPID codes in accordance with an embodiment of the present invention;

FIG. 8 depicts a flow diagram of a method for the processing of audio/video content and received UPID codes at the point of a server and/or a consumption device in accordance with an embodiment of the present invention.

FIG. 9A depicts an example in which the text for the UPIDs according to associated attribute information is overlaid over regularly displayed content in accordance with an embodiment of the present invention;

FIG. 9B depicts an alternative representation in which the text for the UPIDs according to associated attribute information is rendered in a different area of a display in accordance with an embodiment of the present invention;

FIG. 9C depicts an alternative representation in which the text for the UPIDs according to associated attribute information is rendered in a different area of a display and overlays a portion of the regularly displayed content in accordance with an embodiment of the present invention;

FIG. 10 depicts a table which presents attributes for a service that can be referenced using UPID codes in accordance with an embodiment of the present invention;

FIG. 11 depicts a table which presents different modality formats in which a service can be presented and/or rendered in accordance with an embodiment of the present invention;

FIG. 12 depicts a table which presents exemplary consumption devices for the modality field in which product descriptions and services can be implemented in accordance with an embodiment of the present invention;

FIG. 13 depicts a table which presents an exemplary script that can be used to implement Twitter messaging in accordance with an embodiment of the present invention;

FIG. 14A depicts a flow diagram of a method for processing UPID information for an identified product in accordance with an embodiment of the present invention; and

FIG. 14B depicts a flow diagram of a method for processing UPID information for an identified service in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide a methods and apparatus for identifying products and services in media content. Although the present invention will be described primarily within the context of identifying products and services using hash codes for upselling products and services identifiable in programming presented on a display, the specific embodiments of the present invention should not be treated as limiting the scope of the invention. It will be appreciated by those skilled in the art and informed by the teachings of the present invention that the concepts of the present invention can be advantageously applied for identifying products and services for products and/or services identifiable in any programming presented on any display for purposes other than upselling products and services.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

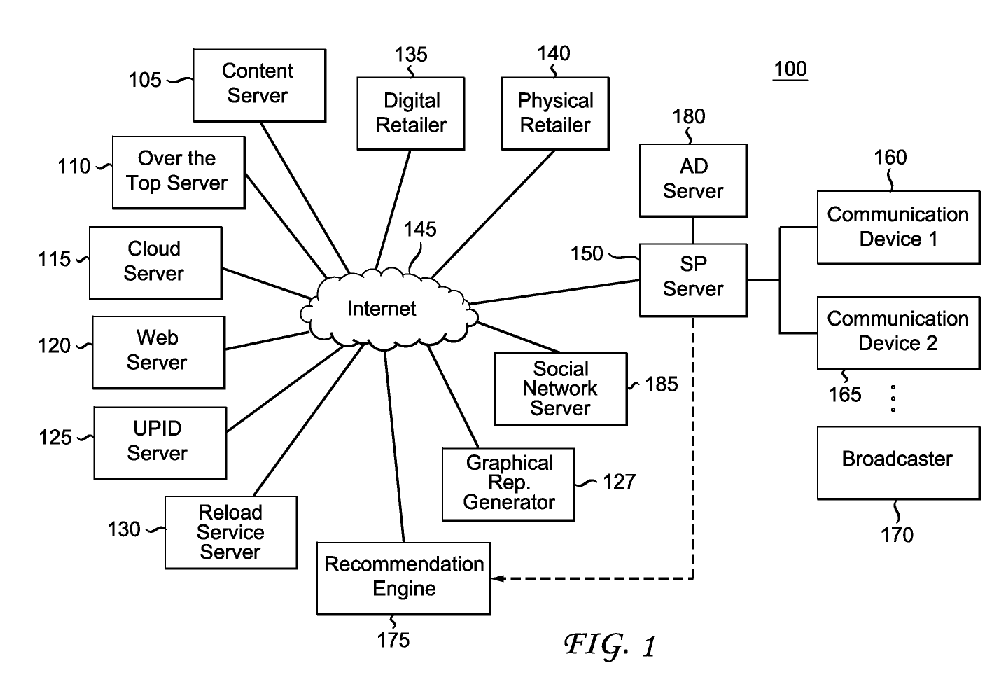

FIG. 1 depicts a high level block diagram of a system for identifying products and services in accordance with an embodiment of the present invention. The system 100 of FIG. 1 illustratively comprises a content server 105 which provides content to a first consumption device 160 and a second consumption device 165 through the internet 145 and a service provider 150. The content server 105 typically provides audio, video, text, interactive services, web services, and the like to a user operating a consumption device such as devices 160 and 165. In FIG. 1, the over the top server 110 is a service that provides audio, video, text, interactive service, web services, and the like to a consumption device such as devices 160 and 165. In the system of FIG. 1, the over the top server 110 can be operated from a subscription service such as NetFlix or Hulu, where the content that a user receives on their consumption device 160, 165 comes from such a server.

The cloud server 115 of FIG. 1 is a server that is operated in the cloud environment such as the ICloud, Amazon, Dropbox environments, in which such a server can be used to deliver content to a user. Typically, the cloud environment is a distributed server environment in which a consumption device running an application can communicate with the server 115, even though the content that comes from the cloud environment comes from another server (or server farm). The web server 120 of FIG. 1 is a server that provides web and/or applications that can be interfaced using a consumption device 160, 165. The web server 120 can operate with Javascript, ASP, a REST framework, HTML, or any other suitable frameworks that can provide web services to consumption devices 160, 165.

In the system 100 of FIG. 1, a unique product id (UPID) server 125 provides references to products and services referred to by a UPID id as described further below. In the system 100 of FIG. 1, the UPID server 125 can be implemented as a server that runs a database running on DB2/SQL, or other database format where queries submitted to the UPID server 125 return information to the device or alternatively can identify a device to which such information is to be returned. More specifically, embodiments of the present invention provide a product database referred to herein as a UPID server 125 used to provide references to products and/or service presented in media content. That is, in various embodiments of the present invention, instead of hard coding specific instances of a metadata “descriptor”, which would be linked to and would always map to the same “essence” or product/service, embodiments of the present invention provide a metadata description format which can change the essence to which a descriptor points. For example, in the system 100 of FIG. 1, an embodiment of the present invention is described in which metadata is provided with content such that descriptors in the metadata point to essences that correspond to physical products and/or services. In the embodiment of the invention of FIG. 1, metadata related references made by, for example the UPID server 125 using UPID codes, can change to what the references point based on the needs of content providers, retailers, service providers, and the like.

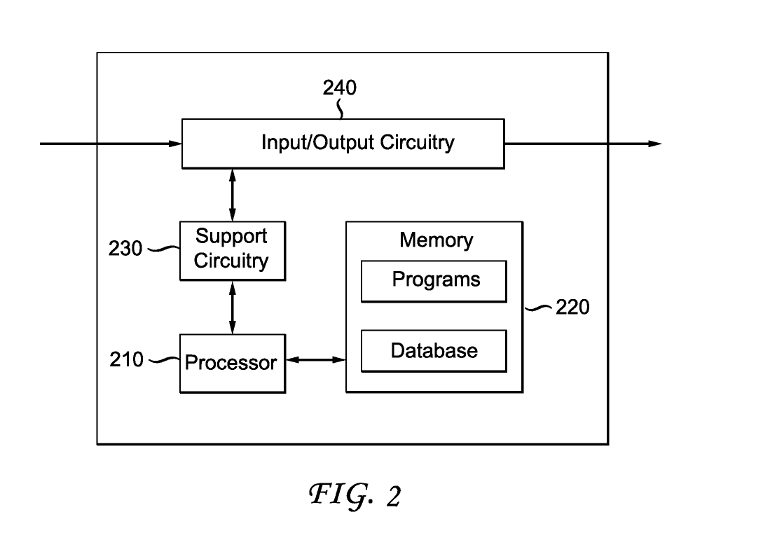

FIG. 2 depicts a high-level block diagram of a UPID server 125 applicable for use in the system 100 of FIG. 1 in accordance with an embodiment of the present invention. More specifically, the UPID server 125 of FIG. 2 illustratively comprises a processor 210 as well as a memory 220 for storing control programs, stored UPID identifiers and the like. The processor 210 cooperates with conventional support circuitry 230 such as power supplies, clock circuits, cache memory and the like as well as circuits that assist in executing the software routines stored in the memory 220. As such, it is contemplated that some of the process steps discussed herein as software processes may be implemented within hardware, for example, as circuitry that cooperates with the processor 210 to perform various steps. The UPID server 125 also contains input-output circuitry 240 that forms an interface between various functional elements communicating with the UPID server 125.

Again, although the UPID server 125 of FIG. 2 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software executed by a processor, hardware, or a combination thereof. In addition, although the UPID server 125 of FIG. 2 is depicted as capable of being a separate component, the functionalities of the UPID server 125 in accordance with the concepts and embodiments of the present invention described herein can be incorporated into an existing system component such as a service provider server, content server and the like.

Referring back to the system 100 of FIG. 1, the related service server 130 provides interactive services that can be delivered with any of the content that comes from servers 105, 110, 115, and/or 120. Examples of related services can include audio, video, text, and/or interactive services which can enhance the delivery of content. For example, a movie from content server 105 can have subtitles and a commentary audio track can be provided by a related service server 130, and some or all of these services can be delivered to a consumption device 160, 165. Although above the system of FIG. 1 is described as providing specific services, in alternate embodiments of the present invention, other types of alternative products and services can be used in accordance with the principles of the present invention.

In the system 100 of FIG. 1, the digital retailer 135 provides a digital version of content that can be communicated to and purchased using a consumption device 160, 165. The content can be purchased in reference to a UPID id referenced by UPID server 125, in a manner described below, although in alternate embodiments of the present invention, other similar implementations can be used as well. Typically, the digital content from the digital retailer 135 can include audio, video, text, interactive services, electronic book content, and the like.

The physical retailer 140 of FIG. 1 delivers a physical good to a user in response to an order placed by a user operating a consumption device 160, 165. For example, in response to a user purchase made with, for example, UPID information, a retailer 140 (e.g., Amazon, Nordstrom, and the like) fulfills the order and ships the ordered product to the user.

In the system 100 of FIG. 1, the Internet 145 is a packet based communication network that operates as a network that connects the respective components of FIG. 1. Although in the system 100 of FIG. 1, the Internet 145 is implemented using a TCP/IP system, in alternate embodiments of the present invention, other variations of a packet based system can be used, as well. In the system 100 of FIG. 1, the Service Provider server 150 is a server that is operated by a service provider which interfaces requests and content to and from Internet 145. Services that can come from the Service Provider server 150 can include video/audio delivered via Internet Protocol television (IPTV), video on demand services, program guide information, cable services, internet telephony (VoIP), QAM modulated programming, web services, and the like. Typically, a user operating a consumption device 160, 165 will have a subscription with a service provider (e.g., AT&T UVerse, Verizon FIOS, Xfinity, MediaCom, and the like) that operates the Service Provider server 150.

In various embodiments of the present invention, consumption devices 160, 165 can comprise any type of device that can be used to consume media. Such devices can be Personal Computers, laptops, tablets, personal data assistant, video game system, set top box, net book, cellular phone, smart phone, digital video recorder, personal media device, audio/video receiver, and/or any other device capable of outputting and audio/video content.

In the system 100 of FIG. 1, the broadcaster 170 is a cable/terrestrial/satellite/IPTV or other type of broadcaster that transmits content to a consumption device 160, 165. In the system 100 of FIG. 1, the broadcaster 170 can be independent of a service provider. For example, a television station can broadcast a terrestrial based ATSC channel to a consumption device 160, 165 through an over the air transmission, whereby a tuner in the consumption device 160, 165 receives and outputs the television program.

In the system 100 of FIG. 1, the recommendation engine 175 comprises a recommendation system in which different programming and content selections can be provided to a consumption device 160, 165 in response to a user profile. More specifically, various programming options that a user has consumed and/or rated by a user can be used to develop a profile for that specific user, such that the recommendation engine 175 can provide content recommendations to a user via a consumption device 160, 165. Such recommendations comport to content that was received from, for example, the servers 105, 110, 115, 120, 130, and/or the broadcaster 170 of FIG. 1. Although in FIG. 1, the recommendation engine 175 is depicted as a separate component, in alternate embodiments of the present invention, the recommendation engine 175 can also be implemented as an integrated component or function of the service provider 150 where the content selections made by a user operating a consumption device 160,165 are monitored by the recommendation engine integrated into the service provider 150, such that content can be recommended to the user. In such embodiments of the present invention content located locally in the service provider server 150 can be biased in accordance with user preferences.

In the system 100 of FIG. 1, the ad server 180 provides audio/video/text/interactive service advertisements (or a combination thereof) to consumption devices 160, 165. In the embodiment of FIG. 1, the advertising server 180 is in communication with the service provider server 150 such that advertisements can be delivered to user programming in a variety of ways including providing forced advertising breaks in content delivered to a user (regardless of the source), providing banner ads, providing advertising in specified locations in content, and the like. In alternate embodiments of the present invention, advertisements communicated to the user can be selected using software (e.g., AdBlade, DoubleClick, GoogleAdSense, and the like) running on the advertisement server 180 and the advertising selected can be based on the profile of the user, or other type of relevant criteria including geographic information, keywords, IP address, and the like. Although in FIG. 1, the advertisement server 180 is depicted as a separate component, in alternate embodiments of the present invention, the advertisement server 180 can also be implemented as an integrated component or function of the service provider 150.

In the system 100 of FIG. 1, the social network server 185 corresponds to a social networking service such as Facebook, MySpace, LinkedIn, Flicker, Q-Zone, Bebo, Orkut, and/or a messaging service such as Twitter, and the like, through which users can communicate with each other. In the system 100 of FIG. 1, a social networking service can be a source of content as well for a user to consume, where the social networking server 185 can deliver content, can reference content from a different server (105, 110, 115, 120, 130, 150), and/or can provide information about content that can come from a broadcaster 170.

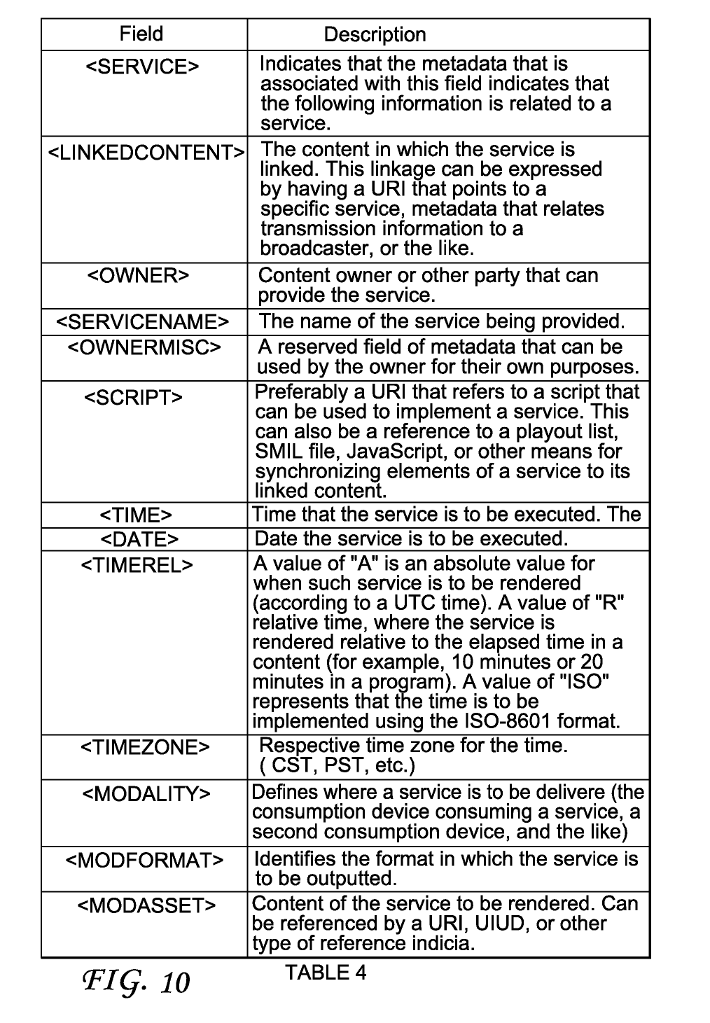

In the system 100 of FIG. 1, a graphical representation generator 127 generates graphical representations of products or services depicted in content being displayed on a display. More specifically, in one embodiment of the present invention, the graphical representation generator 127 generates graphical representation codes, such as QR codes for a particular product or service or object (e.g., text) in the content being presented on a display. That is, by rendering a QR-RAY mode, an object becomes a QR code which can be captured by a mobile communications device. In such embodiments of the present invention, the graphical code representation tracks the respective product, service or object along a display screen as it is being presented on the display. Such an embodiment is discussed further with respect to FIGS. 9A, 9B and 9C, below. Although in FIG. 1, the graphical representation generator 127 is depicted as comprising a separate component, in alternate embodiments of the present invention, the graphical representation generator 127 can comprise an integrated component or program of the UPID server 125 or the service provider server 150.

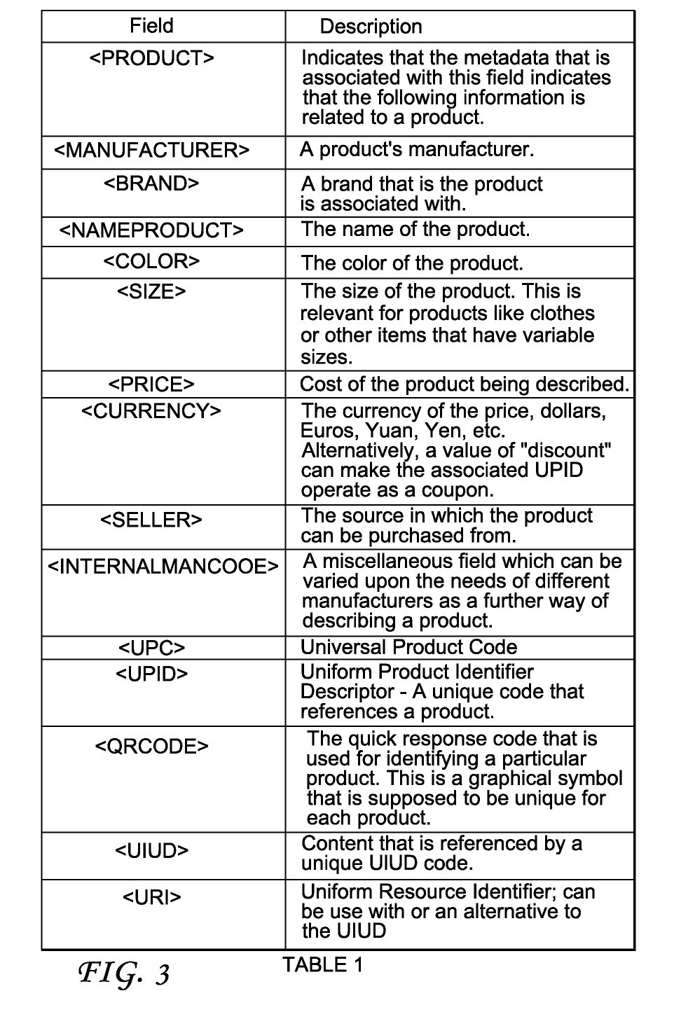

With reference back to the previously mentioned database in the UPID server 125 of FIG. 1, FIG. 3 depicts a table, TABLE 1, which depicts a generic nomenclature used to describe a product and or service in which one or a multiplicity of fields can be used for referencing a product in accordance with one embodiment of the present invention. Within the use of the fields in the example of TABLE 1, <TEXT> describes the field, and the “&” is used to enable the use of multiple fields which can be strung along. The description and fields described in TABLE 1 can be changed as needed and can be implemented as required.

Embodiments of the UPID identifier of the present invention provide a new type of identifier that can be generated from a combination of fields, such as those listed above in Table 1 of FIG. 3, as, in at least one embodiment, a hash (e.g., MD5, MD6, etc.) or other type of unique identifier generating system in which each product referenced has a unique code associated with it. In accordance with various embodiments of the present invention, incorporating fields such as “color” or “size” help distinguish a unique UPID identifier code from internal product codes used by a manufacturer, store, or a UPC. In an embodiment in which MD5 is implemented as a hashing mechanism, in one embodiment of the present invention UPID codes for a generic product can be represented by the metadata fields using a text string in the following format:

<PRODUCT>NULL&<MANUFACTURER>FACTORY&<BRAND>
GENERICBRAND&<NAMEPRODUCT>SOMETHING&<COLOR>GREEN.

The above text string results in a MD5 hash code represented as 54724d0a5e3925663af29bf25d3c4e2c. If the same metadata were the same, where the only field that was changed was the color from green to black, the MD5 hash code would be 57d9c7cd2d9a179fe535578d680b15ab. One aspect of using MD5 is that the hashing technique does not require the use of all fields in the creation of a hash, but is ideal for consistency in the use of all fields. In MD5, if a particular field is missing, the hashing technique can note that missing field and apply the field with a “NULL” value. For example, an example of using the fields from TABLE 1 for an XML document which is returned in response to a UPID code <6524fc68497918c9453adffb2ad976b9> corresponding to a product that is a jacket can be represented as:

<PRODUCT>

<MANUFACTURER>MEMBERSONLY</MANUFACTURER>
<BRAND>DISCOSTYLE</BRAND>
<NAMEPRODUCT>LUKE</NAMEPRODUCT>
<COLOR>GREY</COLOR>
<SIZE>EXTRALARGE</SIZE>
<PRICE>102.22</PRICE>
<CURRENCY>USDOLLAR</CURRENCY>
<SELLER>AMAZON</SELLER>
<INTERNALMANCODE>NULL</INTERNALMANCODE>
<UPC>123456789012</UPC>
<QRCODE>NULL</QRCODE>
<UIUD>NULL</UIUD>
<URI>NULL</NULL>

The above representation can be compared against the XML information for a DVD available for purchase from a physical retailer 140 which is represented by:

<PRODUCT>

<MANUFACTURER>BROADWAYVIDEO</MANUFACTURER>
<BRAND>VALUELINE</BRAND>
<NAMEPRODUCT>MR_BILL'S_COMIC_ADVENTURES</NAMEPRODUCT>
<COLOR>NULL</COLOR>
<SIZE>NULL</SIZE>
<PRICE>29.95</PRICE>
<CURRENCY>USDOLLAR</CURRENCY>
<SELLER>TARGET</SELLER>
<INTERNALMANCODE>DVD</INTERNALMANCODE>
<UPC>123456789022</UPC>
<QRCODE>NULL</QRCODE>
<UIUD>1234567890123456</UIUD>
<URI>WWW.TARGET.COM/DVD/MRBILLFUNHOUSE.XML</URI>

The resulting UPID for the above described product is <96e9dc905966f5dc56ef20bbe18c411d>. See http://jlpoutre.home.xs4all.nl/BoT/Javascript/Utils/md5_hashing.html for an application of an MD5 hashing method.

A third example describes an advertisement that can be used with a program, which can make use of UPID format:

<PRODUCT>

<MANUFACTURER>GUCCI</MANUFACTURER>
<BRAND>NULL</BRAND>
<NAMEPRODUCT>NULL</NAMEPRODUCT>
<COLOR>NULL</COLOR>
<SIZE>NULL</SIZE>
<PRICE>10</PRICE>
<CURRENCY>DISCOUNT</CURRENCY>
<SELLER>NULL</SELLER>
<INTERNALMANCODE>COUPON</INTERNALMANCODE>
<UPC>123456789022</UPC>
<QRCODE>GUCCICOUPON.BMP</QRCODE>
<UIUD>1111111111111116</UIUD>
<URI>WWW.TECHNICOLOR.COM/GUCCI</URI>

The resulting UPID code for the above described product information is <ff06bf74bc44a4f5f0b2a1dcd8f056f8>. This example depicts a reference for a coupon located at WWW.TECHNICOLOR.COM (as referenced in the URI). The coupon can be presented as a QRCODE which is stored at the server as a bitmap, although other graphic file formats can be used, as well as having a QRCODE being generated on the fly. Regardless, whether a QRCODE is used with a product, a reference to a service, a coupon, and the like, the above examples depict how these fields can represent a multitude of different products and services.

In various embodiments of the present invention, UPIDs can be used to create a product database which identifies products that are available, such that any manufacturer or product/service provider can provide a reference to any of their products with a unique UPID within the product database. That is, in various embodiments of the present invention, a universal product database can be created using UPIDs such that any product that is meant to be identified for purposes of, for example, being upsold can be listed in the database.

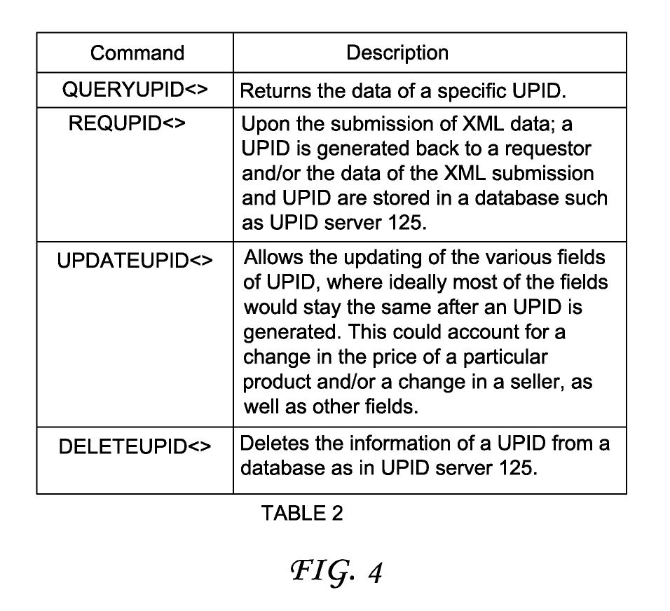

FIG. 4 depicts a table, TABLE 2, which presents different commands that can be submitted to a server, such as the UPID server 125, from which XML data can be returned as described above. For example, the table of FIG. 4 includes such commands as QUERYUPID used to request information of a product/service identified by a unique UPID; REQUPID used to generate a UPID for a product/service upon the submission of XML data; UPDATEUPID which enables the updating of the various fields of a UPID; and DELETEUPID which deletes information of a UPID from a database. Referring back to previous discussion of the mapping between an essence (a product) and a descriptor, in various embodiments of the present invention, a UPID can be implemented as a descriptor which would be related to media content. The UPID can then be referenced against the universal product database for information/advertising about the product (essence) that would correspond to the product or service. The respective fields listed in Table 1 can then be returned to an appropriate device/server/user such that information describing a product can be returned to a requesting user and/or the product can be offered for sale to the user.

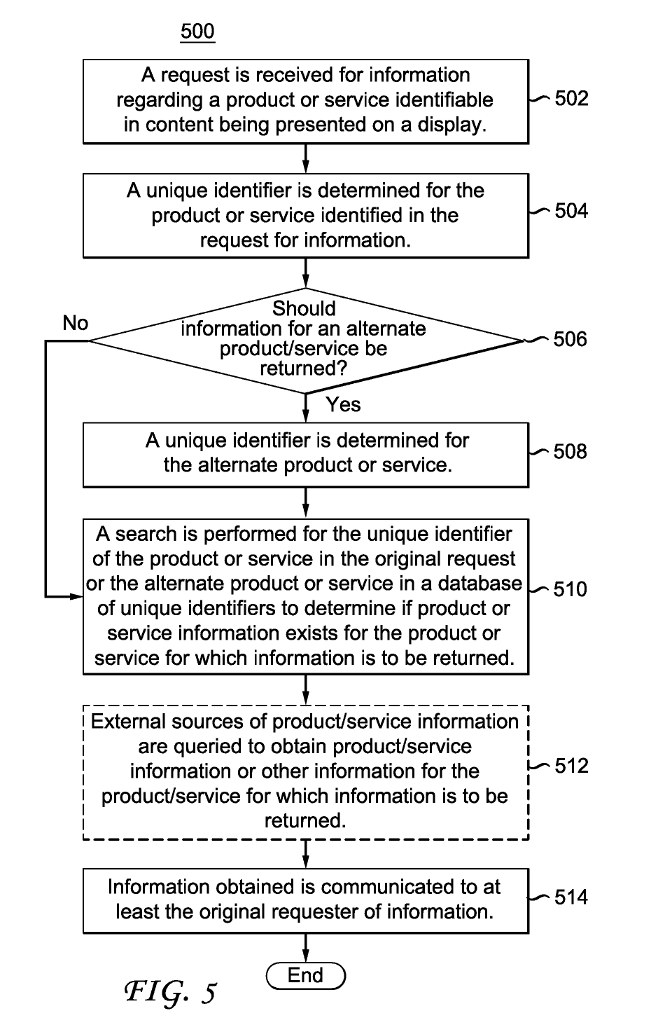

FIG. 5 depicts a flow diagram of a method for identifying products and/or services for obtaining information for the identified products and/or services in accordance with an embodiment of the present invention. The method 500 begins at step 502 at which a request is made by a viewer for information about a product or service identified in programming being presented on a display. In one embodiment of the present invention, a user using a user interface of a consumption device 160,165 requests information about a product or service by generating a QUERYUPID request as depicted in FIG. 2 by, in one embodiment of the present invention, including in the request, information such as some or all of the information listed in Table 1, using the user interface. The QUERYUPID request is received by, in one embodiment, the UPID server 125. The method 500 proceeds to step 504.

At step 504, in response to the received request, a unique identifier is determined for the product or service identified in the original request by, in one embodiment, the UPID server. As described above, in one embodiment of the present invention, a unique identifier is determined for the product/service using a hash code. It should be noted that in alternate embodiments of the present invention, such unique identifiers are previously created and stored and step 506 comprises identifying a product or service using the previously created unique identifiers. In such embodiments of the present invention, the step of 506 for determining a unique identifier comprises receiving the request and associating a previously determined identifier with the product/service identified in the request. The method 500 then proceeds to step 506.

At step 506, it is determined in one embodiment, by the UPID server 125, if information for an alternate product or service should be returned in response to the original request. That is, in one embodiment of the present invention, the UPID server 125 performs a look-up of the UPID code to determine what information, product or service corresponds to the code. A UPID server 125 can be programmed with criteria which results in the favoring of one product/service or type of product/service over other product/service or type of product/service. Such preferences can result in the inclusion of information that can be communicated from an advertising server 180 that enables the ability to, for example, upsell a certain product with existing advertisements and product/service information. Such preferences can be expressed as business rules which can be as simple as referencing a certain field and determining if an alternative product (or vendor) should be returned. That is, information associated with one of the fields in the QUERYUPID request can be changed for example by the UPID server 125, to identify a new product/service or product/service source.

For example, in response to received UPID information, a determination can be made that a product is to be sold by AMAZON (by referencing the <SELLER> field. The UPID server 125, however, can be configured with a preference that a seller, such as TARGET, provides the product identified by the UPID information. As such, the UPID server 125 can perform a review of its configuration to determine if information for an alternative product should be returned to a requester in response to received UPID information. In one embodiment of the present invention, a search for information for an alternate product can be accomplished by searching in the database for UPID identification codes that contain similar fields such as manufacturer, brand, nameproduct, color, and the like where the field is different for the field that identifies the change in product information, such as, in the embodiment above, the field identifying Amazon identifies an alternate seller.

Referring back to step 506, if product/service information for the original product or service originally identified in the QUERYUPID request is to be returned, the method 500 skips to step 510. If product/service information for an alternate product or service is to be returned, the method 500 proceeds to step 508.

At step 508, a unique identifier is determined for the alternate product or service. The method 500 then proceeds to step 512.

At step 510, a database, for example in the UPID server 125, is searched for the unique identifier of the product or service in the original request or the alternate product or service to determine if product or service information exists for the product or service for which information is to be returned. If product or service information exists in the database, the method 500 skips to step 514. If product or service information does not exist in the database, the method 500 proceeds to optional step 512.

At optional step 512, external sources of product/service information are queried to obtain product/service information or other information for the product/service for which information is to be returned. The method 500 proceeds to step 514.

At step 514, information obtained is communicated to the requester, for example via a consumption device 160,165, from which the QUERYUPID request originated. In alternate embodiments of the present invention, the information obtained can additionally or alternatively be communicated to another user(s) identified in the QUERYUPID request or otherwise identified.

The method 500 can then be exited.

In various embodiments of the present invention, the obtained information can be presented in the form of XML data, a web page, and/or can be configured as an advertisement that is ultimately displayed on a consumption device 160,165. In various embodiments of the present invention the information obtained can be presented in at least one of a Picture in Picture format, Picture out of Picture format, banner ad, flash animation and the like.

In an alternate embodiment of the present invention, a QUERYUPID request can be referenced against a database that is operated by a service provider, which can be a network service provider, internet service provider, network operator, and the like.

In yet alternate embodiments of the present invention, a service provider is capable of intercepting requests for a specific UPID and offer information/sales offers for alternate products other than the product that is identified by the unique UPID. That is, in one embodiment of the present invention, the service provider server 150 can intercept a QUERYUPID intended for the UPID server 125 and it is determined at the service provider server 150 whether alternate product or service information should be returned to a requester(s). In the service provider server 150, a rule can be applied to upsell specific products or services. For example, during a NASCAR race, a UPID can be generated by, for example, a user viewing content on a display that corresponds to a particular tire sold by Goodyear. A service provider server 150 can intercept the UPID that is in route to the database of products/services in the UPID server 125 and associate an alternative type of tire (e.g., Michelin) with that UPID and return information/sales offer for the alternate product to a source of the UPID request. It should be noted that although the tire type and manufacturer has changed, the other attributes of the tire referenced by the UPID would remain the same.

In various embodiments of the present invention, the use of UPID codes or other types of metadata that can be used to identify relevant products or services in accordance with the present invention can be embedded within media content during the workflow creation process of such media. That is, such UPID codes can be placed in auxiliary data that accompanies such media. In one embodiment of the present invention, the auxiliary data can be similar in format to the subtitle information that is transmitted with a program, where instead of having an alternative language (such as Spanish or French), an alternative track can be included for text which described the embedded UPID codes. Such text can be rendered on screen at specified times which can be specified using attribute codes.

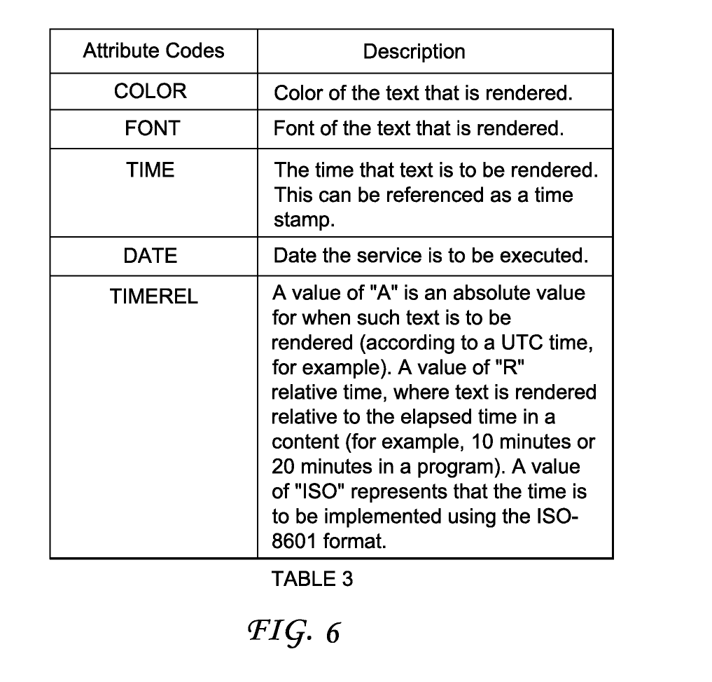

For example, FIG. 6 depicts a table, TABLE 3, which presents examples of information that can be placed within the auxiliary information. As depicted in FIG. 6, some of the attribute codes can include color of text to be rendered, font of the text to be rendered, the time that text is to be rendered, date a service is to be executed, duration of the displayed text, a graphic (either embedded or referenced by a URI) that is to be rendered with the displayed text, coordinates of where the displayed text is to be centered, which can be defined by X and Y coordinates in pixels, or in any other relevant unit, size of the area to be occupied by the text and/or graphic and the UPID code that is sent to a relevant server depending on the operation decided to by a user.

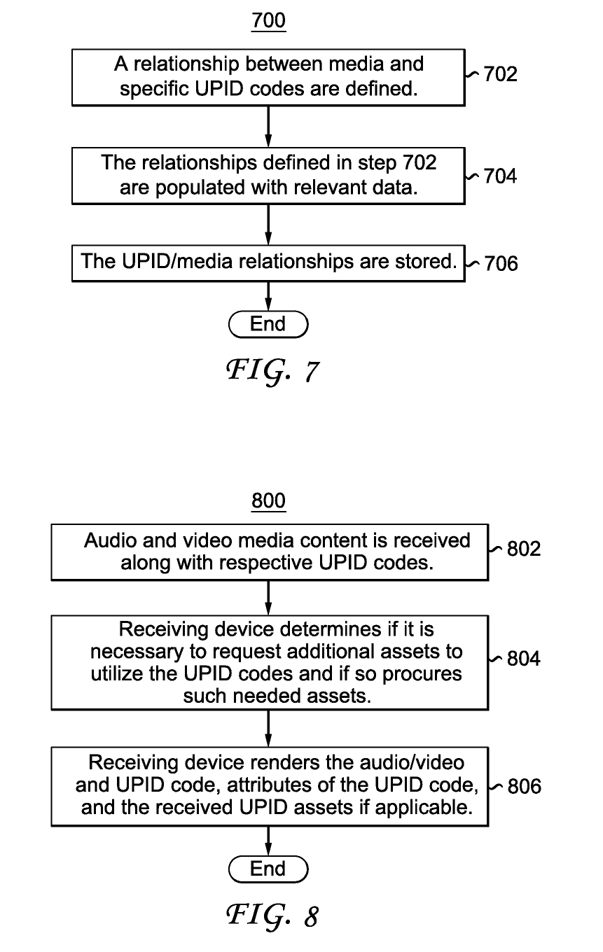

FIG. 7 depicts a flow diagram of a method for associating media assets, attributes codes, and UPID codes in accordance with an embodiment of the present invention.

The method 700 begins at step 702 at which a relationship between media and specific UPID codes are defined. That is, in one embodiment of the present invention, in the workflow process, a user interface can be implemented which enables an operator to specify for a specific media asset, a specific UPID that pertains to such an asset. Examples of operational parameters for defining UPID applications are defined in TABLE 3 of FIG. 6 as attributes which can be metadata fields with corresponding entries. The method 700 then proceeds to step 704.

At step 704, the relationships defined in step 702 are populated with the relevant data. For example, in one embodiment, a “third track” of metadata is created that accompanies the audio and video file references with the MXF (Media Exchange Format) metadata. That is, in one embodiment of the present invention, the description can be implemented in accordance with the generation of media assets at the workflow creation level as MXF files which would comply with SMPTE 377M and use the descriptive metadata outlined in SMPTE EG42. The present description could introduce an auxiliary set of metadata terms and uses that are novel, but would operate within the MXF framework, although such concepts and metadata can be adapted for other production formats.

Returning to step 704, the UPID codes can be matched up with specific time codes that are associated with the audio and video files. For example, at time “t1” with a respective timecode in the “program” a first UPID can be referenced and at a second time “t2” with a timecode, a second UPID can be referenced as well. These types of UPIDs can be designated serially for a program. In addition, spatial information can be used for where the information in combination with a UPID is to be placed on a screen, when the audio and video information is rendered. The method then proceeds to step 706.

At step 706, the UPID/media relationships are stored. That is, the MXF information and the associated program (audio, video, auxiliary data if any, and UPID codes) can be stored for subsequent delivery to, for example, a playout center, stored on a server for broadcast, or other means for delivery. In an alternate embodiment of the present invention, UPIDs and relevant information are embedded into the auxiliary information that is associated with a program. For example, if audio and video are transmitted as an MPEG-2 transport stream, additional auxiliary information, comporting to the UPID codes and related information, can be designated with specifics Packet Identifiers whereby such information is part combined with the audio, video, and auxiliary information. In alternate embodiments of the present invention, the information can be delivered in a format such as SILVERLIGHT, FLASH, HTML5, and the like.

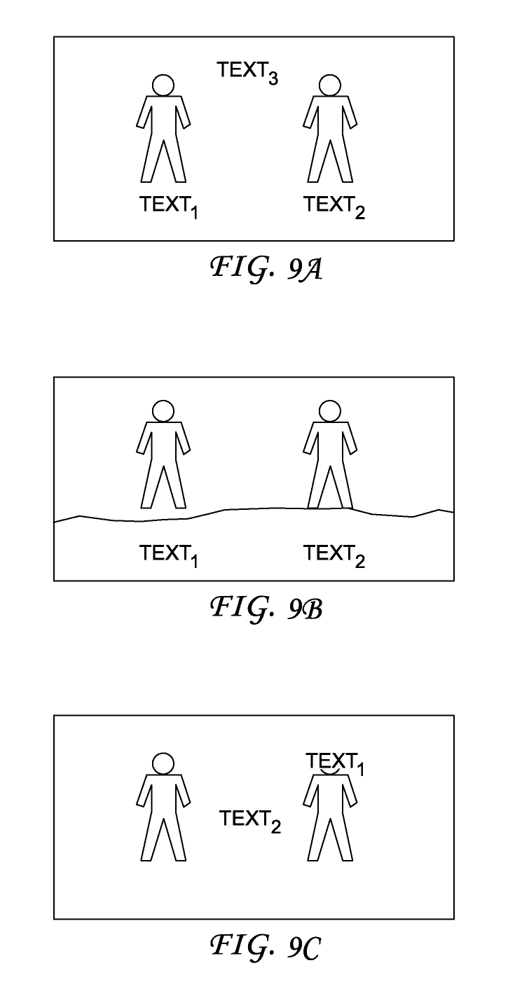

FIG. 8 depicts a flow diagram of a method for the processing of audio/video content and received UPID codes at the point of a server and/or a consumption device. The method 800 of FIG. 8 begins at step 802 at which audio and video media content is received along with respective UPID codes. For this present example, the received data in step 802 is in a form of an MPEG-2 transport stream where the audio, video, and UPID information can be distinguished by using UPID codes. In one embodiment of the present invention, a receiving device (e.g., a consumption device 160,165), a server (150), or other receiving device receives audio/video/UPID information from a communication network such as the internet 145. This information can be received in response to a request for content from a broadcaster 170, an IPTV transmission, and the like. The method 800 then proceeds to step 804.

At step 804, the device that receives the audio/video/UPID information determines if it needs to request additional assets to utilize the UPID codes and if so procures such needed assets. Examples of additional assets needed can included the XML description of a product that corresponds to a UPID code, an additional audio/video/web script that comports to the UPID, a graphic file, webpage, programming script, and the like. The method 800 then proceeds to step 806.

At step 806, the receiving device renders the audio/video and UPID code, attributes of the UPID code, and the received UPID assets if applicable. Examples of such rendering are depicted in FIGS. 9A, 9B and 9C. For example, FIG. 9A represents an example in which TEXT1, TEXT2, and TEXT3 are overlaid over the regularly displayed content. In FIG. 9A, UPID attributes define TEXT1, which comprises text defined by a first UPID, and TEXT2, which comprises text defined by a second UPID, both rendered on a display device with video information, represented in FIGS. 9A, 9B and 9c by simple figures. In FIG. 9A, TEXT3 is text that comprises text defined by a third UPID3. In various embodiments of the present invention, such text can be rendered using a video processor and/or an on screen display that is present in the device that receives the MPEG-2 transport stream.

FIG. 9B depicts an alternative embodiment in which text for the UPIDs according to associated attribute information is rendered in a different area of a display as compared to FIG. 9A. That is, as depicted in FIG. 9B, text is rendered in a lower area of a display screen in accordance with respective associated attribute information in the UPID codes.

FIG. 9C depicts an alternative representation in which text for the UPIDs according to associated attribute information is rendered in a different area of a display and actually overlays a portion of the regularly displayed content (i.e., the head of one of the objects is not visible).

In alternate embodiments of the present invention, instead of rendering text as depicted in FIGS. 9A-9C, graphical representation codes such as Quick Response (QR) codes are rendered on the display instead. More specifically, in such an embodiment, a user can be interested in information shown on a display for, for example, a particular product or service or actor (i.e., TEXT1 as depicted in FIG. 9A). By rendering a QR-RAY mode, the text becomes QR codes which can be captured by a mobile device/camera. In such embodiments, a service, website, coupon, offer to buy a shown product, actor information, or other type of service can be accessed using the QR code.

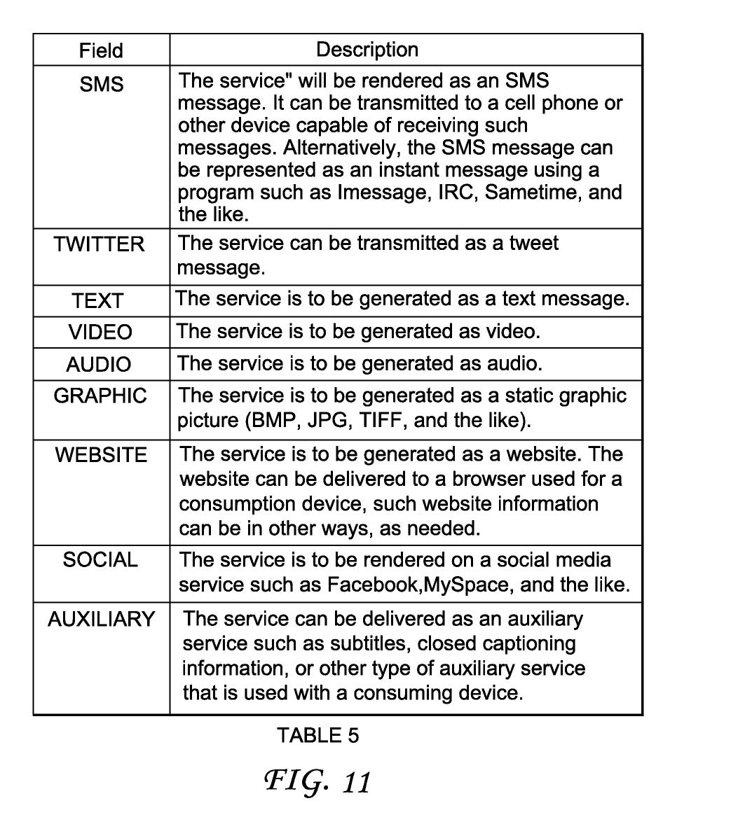

FIG. 10 depicts a table, TABLE 4, which presents attributes for a service that can be referenced using UPID codes in accordance with an embodiment of the present invention. As depicted in the table of FIG. 10, the generation of a corresponding code can be done in a similar manner as described above for a product. In the embodiment of FIG. 10, it is to be assumed that a service represents a related service for content. For example, if a character in a movie receives a text message (SMS), a UPID code embedded in the auxiliary information associated with the movie can trigger that a version of the SMS be sent to a user watching the movie. Other types of services are meant to be delivered to the consumption device that a user is using to consume media and/or other consumption devices that are used. More specifically, in various embodiments of the present invention, while content is being consumed on a main screen, a second consumption device can receive the related services, for example, from server 130, which correspond to the content being displayed on the main screen. As previously described, the relationship between the content and the related services is performed through the UPID codes and the scripts and/or XML that can be executed while the content is being consumed. As depicted in FIG. 10, some of the fields can include a Service field, LinkedContent field, Owner field, Script field, Time, Date and TimeRel fields, a Modality field and others.

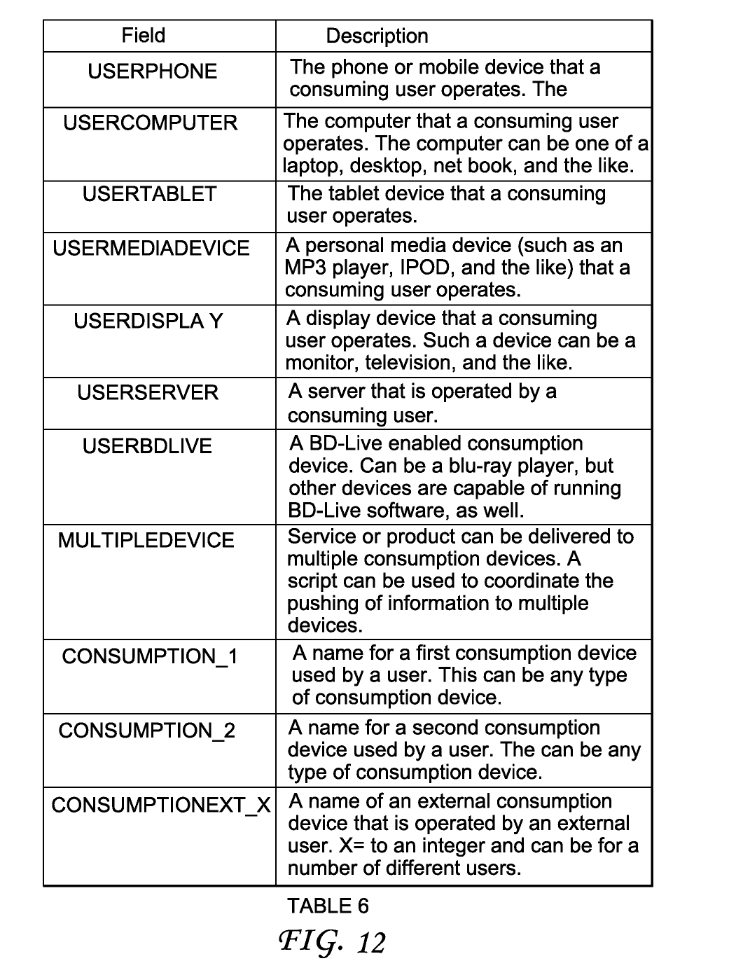

FIG. 11 depicts a table, TABLE 5, which presents different modality formats in which a service can be presented and/or rendered in accordance with an embodiment of the present invention. The use of the term used in the field will tell a rendering device (such as the related server 130) how to generate such a service. For example, the fields in Table 5 of FIG. 11 identify such services as SMS, Twitter, text, video, audio, graphic, website, social and auxiliary services.

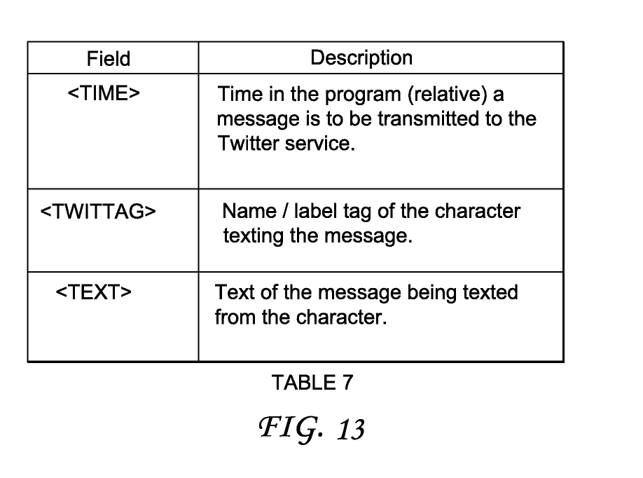

FIG. 12 depicts a table, TABLE 6, which presents exemplary consumption devices for the modality field in which product descriptions and services can be implemented in accordance with the various concepts of the present invention described herein. For example, some of the consumption devices identified in Table 6 of FIG. 12 include USERPHONE, USERCOMPUTER, USERTABLET, USERMEDIADEVICE, USERDISPLAY, USERSERVER, MULTIPLEDEVICE and others.

An exemplary XML form for an SMS service that is linked with a television program is depicted below. In the example below, the television program is transmitted from a server (such as servers 105, 110, 115, 120, 150) as streamed video, video on demand, IPTV, and the like.

<SERVICE>

<LINKEDCONTENT>www.technicolor.com/quantumleap/quantumleapseas

on3episode2.asf</LINKEDCONTENT>

<OWNER>UNIVERSALSTUDIOS</OWNER>
<SERVICENAME>SAM_MESSAGE1</SERVICENAME>
<OWNERMISC>NULL</OWNERMISC>
<SCRIPT>NULL</SCRIPT>
<TIME>00:10:00</TIME>
<DATE>NULL</DATE>
<TIMEREL>R</TIMEREL>
<TIMEZONE>NULL</TIMEZONE>
<MODALITY>USERPHONE</MODALITY>
<MODFORMAT>SMS</MODFORMAT>
<MODASSET>www.technicolor.com/quantumleap/quantumleapseason3ep

isode2/sms/sam_message1.txt< /MODASSET>

In the example above, the UPID for the SMS message service is 8801dd35ed411999b5e1d73c8644a38d. Using the values depicted above, an SMS is sent to a user's phone, 10 minutes into watching the show Quantum Leap.

An exemplary XML script enabling the reception by a user of a representation of messages communicated between characters in a television program named Sherlock from the BBC is depicted below.

<SERVICE>

<LINKEDCONTENT>www.technicolor.com/BBCAMERICA/sherlock/sherlo

ckseason1episode3.asf</LINKEDCONTENT>

<OWNER>BBC</OWNER>
<SERVICENAME>SHERLOCK_TWEETS1</SERVICENAME>
<OWNERMISC>PREMIUM</OWNERMISC>
<SCRIPT>WWW.TECHNICOLOR.COM/BBCAMERICA/sherlock/sherlocks

eason1episode3/sherlocktweet.txt </SCRIPT>

<TIME>00:00:00</TIME>
<DATE>NULL</DATE>
<TIMEREL>R</TIMEREL>
<TIMEZONE>NULL</TIMEZONE>
<MODALITY>CONSUMPTION_2</MODALITY>
<MODFORMAT>TWITTER</MODFORMAT>
<MODASSET>NULL</MODASSET>

In the example presented above, the UPID for the service is <a87d974d0908f93a6 dbc416b63ebc881>. The messages will be delivered using a platform such as Twitter.

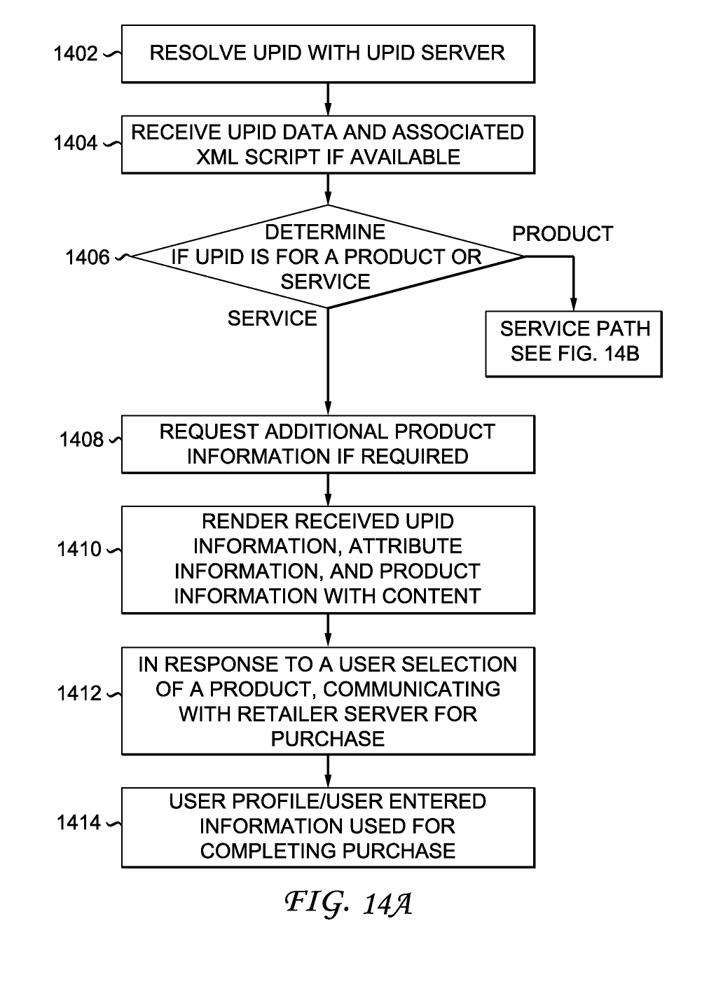

FIG. 13 depicts a table, TABLE 7, which presents an exemplary script that can be used to implement the Twitter messaging referenced in the XML example directly above. That is, many scripts can be written using formats such as SMIL (Synchronized Multimedia Integration Language), Multimedia Message Services, using a proprietary scripting language, and the like. The example of FIG. 13 uses a generic script, for illustrative purposes, with representative fields as depicted in FIG. 13. For example, in Table 7 of FIG. 13 some of the fields include a TIME field which depicts a time in the program at which a message is to be transmitted to a Twitter service, a TWITTAG field which identifies a name/label tag of a character texting the message, and a TEXT field which identifies the text of the message being texted from, for example a character in the content being consumed.

In the above described example, the messages can be transmitted by the related service server 130 directly to a Twitter messaging service (e.g., the social network server 185) which messages are communicated to a consumption device 160, 165. In an alternate embodiment of the present invention, a server can transmit messages to a consumption device 160, 165 at which a user of the consumption device or a browser would process the messages. In yet an alternate embodiment of the present invention, the messages a translated into an RSS feed, such that the various messages of the feed are broadcasted to a consumption device 160, 165 as indicated in a time command.

In linking the various modality fields (e.g., USERCOMPUTER, USERPHONE, and the like), a device such as the service provider server 150 can interoperate with another server, such as servers 105, 110, 115, 120, and the like, to determine how the modality field relates to a user. More specifically, in one embodiment of the present invention, the service provider server 150 can keep data, for example in the form of profile information, which associates the various modality fields to specific user devices. For example, when the service provider server 150 receives a query requesting USERPHONE information; the service provider server 150 returns a phone number, if the request comes from an authorized source. Similarly, if the service provider server 150 receives a query requesting resolution information for a USERTABLET, USERCOMPUTER, USERSEVER, and the like, the service provider server 150 can provide an IP address and port, MAC address, NetBios, or other identifying information of the consumption device that is to receive content and/or a related service. In an alternate embodiment of the present invention, however, a lookup of the information can be performed by using a UPnP, DLNA, or HDMI lookup to determine the media capabilities of the consumption devices 160, 165.

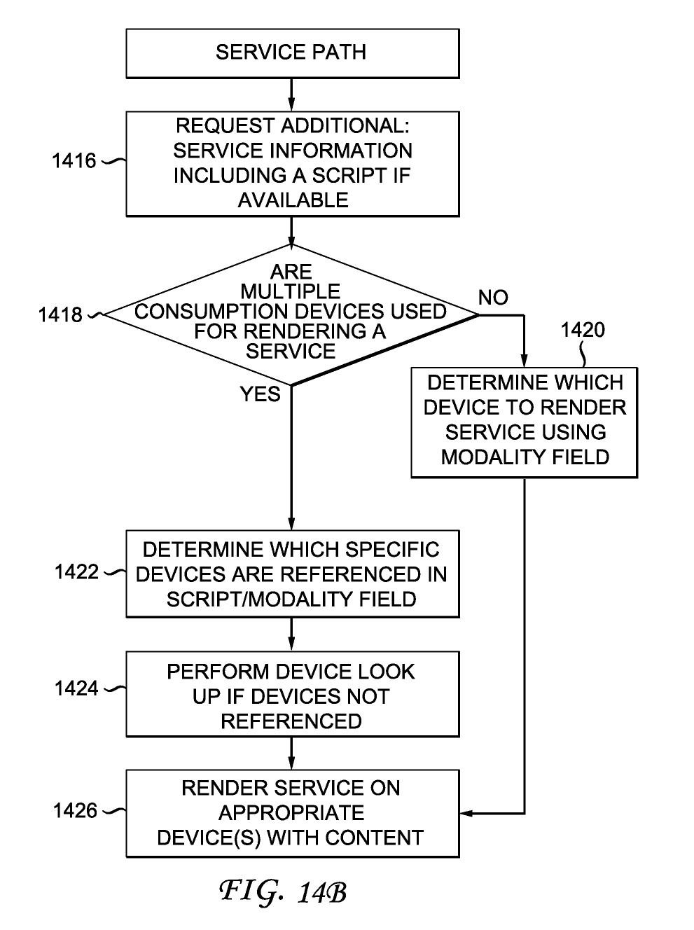

FIGS. 14A and 14 B depict a flow diagram of a method for processing UPID information for an identified product and service, respectively, in accordance with an embodiment of the present invention. The method 1400 begins in FIG. 14A at step 1402 at which a UPID received, for example along with media content, is resolved with the UPID server 125. In one embodiment, this step is performed by a consumption device 160, 165 that receives media and requests information from a UPID server 125. In alternate embodiments of the present invention, this step is performed by a server or other device that operates between a consumption device 160, 165 and a device that delivers content with UPIDs, such as servers 105, 110, 115, 120 and the like or broadcaster 170. More specifically, a service provider server 150 can intercept the UPID information and request alternate information from a UPID server 125. The method 1400 then proceeds to step 1404.

At step 1404, requested UPID data/information is communicated from the UPID server 125 to the device that requested such information or, alternatively, the requested information is redirected to alternate devices such as consumption devices 160, 165. The received information can comprise additional UPIDs, UPID attributes, and various XML formatted information as described above. The method 1400 then proceeds to step 1406.

At step 1406, a receiver of the UPID determines if the UPID corresponds to a product or a service. In one embodiment of the present invention such determination can be made using the title information used in the XML file, and alternatively can be made using a field attribute. If a UPID pertains to a product, the method 1400 proceeds to step 1408 and FIG. 14A. If a UPID pertains to a service, the method 1400 proceeds to step 1416 and FIG. 14B.

At step 1408, additional information can be requested about the UPID if needed. More specifically, in such an embodiment, to process/render the UPID additional information such as information used for an advertisement, product information, and the like, can be required, where such information can come from a related service server 130, ad server 180, and the like. The method 1400 then proceeds to step 1410.

At step 1410, information related to the UPID (such as attribute information) is rendered with the content in the manner specified in the XML and/or in other UPID associated information. The method 1400 then proceeds to step 1412.

At step 1412, if a user expresses interest in purchasing a certain product (upselling . . . ), a communication is transmitted to a retailer server, such as 135 or 145, for fulfilling a purchase order. The method 1400 then proceeds to step 1414.

At step 1414, a purchase is finalized by entering in information about a user related to the purchase. In addition, user profile information can be used for completing a purchase. More specifically, pre-stored information, such as user profile information and credit card information, or other ways of completing an electronic commerce based transaction can be used to enable a user to purchase the product specified in the UPID.

At service step 1416, additional information can be requested from a UPID server for a service as described above in step 1408 for a product. The method 1400 then proceeds to step 1418.

At step 1418, a determination is made for a service whether or not the service will be rendered on multiple devices. In one embodiment of the present invention, this can be indicated in the modality information that comes with the XML file and/or script that comes from the UPID identification. In such an embodiment, if the modality indicates that a single device is to be used for rendering a service, the method 1400 proceeds to step 1420. If the modality indicates that multiple devices are to be used for rendering a service, for example in a modality called MULTIPLEDEVICES, the method 1400 proceeds to step 1422.

At step 1420, a single device to be used for rendering the service is determined using the modality fields. More specifically, in one embodiment of the present invention a device to be used to render the service is identified in the script itself, and the service provider server 150 can assists in determining the specific device to be used. In alternate embodiments of the present invention, the related service server 130 can provide various services referenced in a script. The method 1400 then proceeds to step 1426.

At step 1422, specific devices to be used for rendering the service are determined using the modality fields. The method 1400 then proceeds to step 1424

At step 1424 a script is referenced which is associated with the UPID service, in which the script identifies which consumption devices 160, 165 should receive what part of a service. For example, in one embodiment of the present invention, a USERPHONE could receive an SMS while a USERCOMPUTER could receive an HTML code for use in a browser, as aspects of the same service. A script can also use the terms CONSUMPTION_1 and CONSUMPTION_2 which are generic references to consumption devices. In such a case, a server, such as the related service server 130, determines to which consumption devices a service should be directed. This can be accomplished by using an intermediary such as the service provider server 150 which interacts with consumption devices 160, 165, in which a user or the modes implemented by a user can specify which device is a first consumption device and which device is a second consumption device.

In alternate embodiments of the present invention, this can be accomplished by determining which device is being used to consume media wherein media types are prioritized (i.e., video over audio over internet service/game, etc.). In such an embodiment, the service provider server 150 can make a determination, for example, that a device receiving a video transmission (e.g., an IPTV program) is the primary or first consumption device while a device running an e-mail program is the second device. That is, in the described embodiment, video and audio applications take precedence over other types of applications (e.g., e-mail/twitter/instant messaging/web browser). The method 1400 then proceeds to step 1426.

At step 1426, the service is rendered on the appropriate devices. That is, regardless of how the related service server 130 gets this information, the server transmits the appropriate service to the appropriate device at the times specified in a script, or in response to other instructions. The method 1400 can then be exited.

Having described various embodiments for a method, apparatus and system for identifying products and services (which are intended to be illustrative and not limiting), it is noted that modifications and variations can be made by persons skilled in the art in light of the above teachings. It is therefore to be understood that changes may be made in the particular embodiments of the

invention disclosed which are within the scope and spirit of the invention. While the forgoing is directed to various embodiments of the present invention, other and further embodiments of the invention may be devised without departing from the basic scope thereof.

1. A method for identifying products and services for obtaining information, comprising:
receiving a request for information regarding a product or service identifiable in content being presented on a display;
in response to the received request, determining a unique identifier for the product or service;
determining if information for an alternate product or service should be returned in response to the request;
if alternate product or service information should be returned in response to the request, determining a unique identifier for the alternate product or service; and
searching for the unique identifier of the product or service in the original request or the alternate product or service in a database of unique identifiers to determine if product or service information exists for the product or service for which information is to be returned.

2. The method of claim 1, wherein said unique identifiers are determined using a hash code.

3. The method of claim 2, wherein the hash code comprises at least one of an MD5 hash code and an MD6 hash code.

4. The method of claim 1, comprising communicating obtained information to at least an originator of the request for information.

5. The method of claim 1, comprising communicating related information found in the database to a device identified by the request for information.

6. The method of claim 1, comprising communicating with third party sources of product and service information to obtain product or service information related to the unique identifier for which information is to be returned.

7. The method of claim 1, wherein the content being presented on the display comprises at least one graphical code representation of a product, service or object in the content being presented on the display such that a mobile communications device is able to interact with the graphical code representations.

8. The method of claim 7, wherein a mobile communications device scans the graphical code representations to identify a unique code of the graphical representation such that, in response to the scanning of the graphical representation, the database of unique identifiers is searched to determine if product or service information exists for the product or service related to the scanned graphical representation.

9. The method of claim 8, wherein information found in the database is communicated to the mobile communications device.

10. The method of claim 7, wherein the graphical code representation comprises a QR code.

11. The method of claim 7, wherein the graphical code representation tracks the respective product, service or object along the display screen as it is being presented on the display.

12. The method of claim 1, wherein the product or service information comprises sales information for a product or service.

13. The method of claim 1, wherein the unique identifier comprises a unique code representation of a compilation of XML fields identifying the product or service.

14. The method of claim 13, wherein one or more of the fields in the compilation is changed to identify a different product or service, resulting in a different unique code representation for the different product or service.

15. An apparatus comprising a memory for storing control programs and product and service information and a processor for executing the stored control programs, the apparatus configured to:
receive a request for information regarding a product or service identifiable in content being presented on a display;
in response to the received request, determine a unique identifier for the product or service;
determine if information for an alternate product or service should be returned in response to the request;
if alternate product or service information should be returned in response to the request, determine a unique identifier for the alternate product or service;
search for the unique identifier of the product or service in the original request or the alternate product or service in a database of unique identifiers to determine if product or service information exists for the product or service for which information is to be returned; and
communicate related information found in the database to a device identified by the request for information.

16. The apparatus of claim 15, comprising a graphical code generator for generating graphical code representations of a product or service in the content.

17. A method for identifying products and services, comprising:
establishing a relationship between objects in media content and unique code identifiers;
populating the established relationship with relevant data; and
storing the populated, established relationship.

18. The method of claim 17, wherein the populating step comprises creating a metadata track that accompanies audio and video files in the media content, the metadata track containing information describing an object that is related to a respective unique code identifier.

19. The method of claim 18, wherein the description is implemented in accordance with generation of media assets at the workflow creation level as MXF files which comply with SMPTE 377M and use descriptive metadata outlined in SMPTE EG42.

20. The method of claim 17, wherein said objects comprise products, services or text in the media content.

21. A method for upselling a product or service identified in media content presented on a display, comprising:
requesting information associated with a received unique identifier;
upon receiving information associated with the unique identifier, determining if the unique identifier identifies a product or service;
if the unique identifier identifies a product:
requesting additional information regarding the product if necessary;
rendering the unique identifier to identify a specific product;
communicating with a retailer for initiating a purchase order for the identified product; and
using user profile information to complete the purchase order; and
if the unique identifier identifies a service:
requesting additional information regarding the service if necessary; and
determining a number of devices that are to be used to render the service;
if a single device is be used to render the service, identifying the single device using a modality field in the unique identifier and the rendering the service on the single device;
if multiple devices are to be used to render the service:
determining the multiple devices using at least one modality field in the unique identifier;
determining a location of the multiple devices if not referenced in the modality field; and
rendering the service on the multiple devices.
